(19) United States
(12) Patent Application Publication
(10) Pub. No.: US 2021/0296950 A1
(43) Pub. Date: Sep. 23, 2021

(54) ROTOR, ELECTRIC MOTOR, COMPRESSOR, AND REFRIGERATING AIR CONDITIONING DEVICE

(71) Applicant: Mitsubishi Electric Corporation, Tokyo (JP)

(72) Inventor: Kazuhiko BABA, Tokyo (JP)

(21) Appl. No.: 17/262,011

(22) PCT Filed: Sep. 10, 2018
(86) PCT No.: PCT/JP2018/033425

§ 371 Date: Jan. 21, 2021

(51) Int. Cl. H02K 1/27; H02K 1/28; H02K 21/16; F25B 31/02

(52) U.S. Cl. CPC H02K 1/2766; F25B 31/026; H02K 21/16; H02K 1/28

(57) ABSTRACT

A rotor includes a permanent magnet, a rotor core, and a holding part covering an outer peripheral surface of the rotor core. The rotor core includes a magnet insertion hole, an inner core part, an outer core part, and a connecting core part. The holding part is in contact with part of the outer peripheral surface of the rotor core other than an inter-pole part, and is not in contact with the outer peripheral surface of the rotor core at the inter-pole part.

### CROSS REFERENCE TO RELATED APPLICATION

This application is a U.S. national stage application of International Application No. PCT/JP2018/033425 filed on Sep. 10, 2018, the contents of which are incorporated herein by reference.

### TECHNICAL FIELD

The present invention relates to a rotor for an electric motor.

### BACKGROUND

A rotor in which permanent magnets are embedded in a rotor core has been generally used as a rotor for an electric motor (see, for example, Patent Reference 1). In such a rotor, part of magnetic flux from permanent magnets flows into a region between ends of the permanent magnets and an outer peripheral surface of a rotor core (hereinafter referred to as a connecting core part). Such magnetic flux is called leakage flux. When leakage flux occurs, a magnetic force of the permanent magnets cannot be effectively used. In view of this, it is desirable to reduce the width of the connecting core part in the radial direction in order to reduce leakage flux.

### PATENT REFERENCE

Patent Reference 1: Japanese Patent Application Publication No. H09-9537

In the case where the width of the connecting core part of the rotor core is small, however, large stress is applied to the connecting core parts due to centrifugal force occurring in high-speed operation of the rotor, resulting in deformation of the connecting core part. On the other hand, in a case where the width of the connecting core part is large, the rotor can rotate at high speed, but leakage flux increases. Consequently, a magnetic force of the permanent magnets cannot be efficiently used, resulting in a decrease in efficiency of the electric motor. That is, it is difficult for the conventional technique to achieve both high-speed rotation of the rotor and an increase in efficiency of the electric motor.

### SUMMARY

It is an object of the present invention to increase strength of a rotor, thereby enabling high-speed rotation of the rotor, and reduce leakage flux in the rotor, thereby enhancing efficiency of an electric motor including the rotor.

A rotor according to the present invention is a rotor including a magnetic pole center part and an inter-pole part, and includes: at least one permanent magnet; a rotor core including a magnet insertion hole including a first opening in which the at least one permanent magnet is disposed and a second opening in which the at least one permanent magnet does not disposed, an inner core part famed on an inner side with respect to the magnet insertion hole in a radial direction, an outer core part famed on an outer side with respect to the magnet insertion hole in the radial direction, and a connecting core part famed between an outer peripheral surface of the rotor and an end of the magnet insertion hole in a circumferential direction; and a holding part covering an outer peripheral surface of the rotor core, wherein the holding part is in contact with part of the outer peripheral surface of the rotor core other than the inter-pole part and is not in contact with the outer peripheral surface of the rotor core at the inter-pole part.

According to the present invention, strength of the rotor increases, thereby enabling high-speed rotation of the rotor, and leakage flux in the rotor is reduced, thereby enhancing efficiency of an electric motor including the rotor.

### BRIEF DESCRIPTION OF THE DRAWINGS

FIG. 1 is a cross-sectional view schematically illustrating a configuration of an electric motor according to a first embodiment of the present invention.

FIG. 2 is a cross-sectional view schematically illustrating a configuration of a rotor.

FIG. 3 is a cross-sectional view schematically illustrating the configuration of the rotor.

FIG. 4 is an enlarged view schematically illustrating a configuration of a part of the rotor.

FIG. 5 is a diagram illustrating another example of a rotor core.

FIG. 6 is a cross-sectional view schematically illustrating the configuration of the rotor.

FIG. 7 is a cross-sectional view schematically illustrating a configuration of a compressor according to a second embodiment of the present invention.

FIG. 8 is a diagram schematically illustrating a configuration of a refrigerating air conditioning device according to a third embodiment of the present invention.

### DETAILED DESCRIPTION

### First Embodiment

In an xyz orthogonal coordinate system shown in each drawing, a z-axis direction (z axis) represents a direction parallel to an axis Ax of an electric motor 1, an x-axis direction (x axis) represents a direction orthogonal to the z-axis direction (z axis), and a y-axis direction represents a direction orthogonal to both the z-axis direction and the x-axis direction. The axis Ax is a rotation center of a rotor 3. A direction parallel to the axis Ax is referred to as an “axial direction of the rotor 3” or simply an “axial direction.” A radial direction refers to a direction of a radius of the rotor 3, and it is a direction orthogonal to the axis Ax. An xy plane is a plane orthogonal to the axis direction. Arrow D1 represents a circumferential direction about the axis Ax (hereinafter simply referred to as a “circumferential direction”).

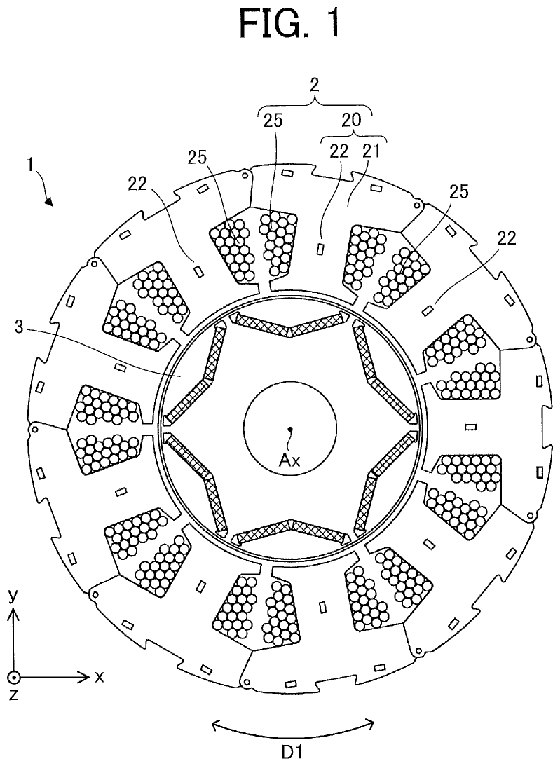

FIG. 1 is a cross-sectional view schematically illustrating a configuration of an electric motor 1 according to a first embodiment of the present invention. FIG. 1 shows a cross section of the electric motor 1 in the xy plane.

The electric motor 1 includes a stator 2 and the rotor 3 rotatably disposed inside the stator 2. A space of 0.3 mm to 1 mm is formed between the stator 2 and the rotor 3. The electric motor 1 is, for example, an interior permanent magnet electric motor. The electric motor 1 is used for, for example, a rotary compressor.

The stator 2 includes a stator core 20 and a coil 25 wound around the stator core 20. The stator core 20 is constituted by a plurality of electromagnetic steel sheets. The stator core 20 is formed by, for example, stacking a plurality of electromagnetic steel sheets in the axial direction. The thickness of each electromagnetic steel sheet is, for example, 0.1 mm to 0.7 mm. In this embodiment, the thickness of each electromagnetic steel sheet of the stator core 20 is 0.35 mm. The plurality of electromagnetic steel sheets are fixed by swaging.

The stator core 20 includes a yoke 21 and a plurality of teeth 22. The yoke 21 has a ring shape. In other words, the yoke 21 extends in the circumferential direction. Each of the teeth 22 extends in the radial direction from the yoke 21. In the example illustrated in FIG. 1, the stator core 20 includes nine teeth 22.

A space between adjacent ones of the teeth 22 is a slot in which the coil 25 is disposed. A tooth front end is formed at a front end of each tooth and extends in the circumferential direction.

A stator winding is wound around each tooth 22 and thus the coil 25 is formed. The stator winding is, for example, a magnet wire. An insulator is preferably disposed between the coil 25 and each tooth 22. The coil 25 is a three-phase coil and a Y connection, for example.

In the example illustrated in FIG. 1, the stator core 20 is constituted by a plurality of blocks (specifically, nine blocks). Each block has one tooth 22. Adjacent ones of the blocks are coupled to each other at a thin portion of the yoke 21.

In the fabrication process of the stator core 20, for example, nine blocks are arranged in a line, and in this state, a magnet wire 80 is wound around each tooth 22 in 80 turns. These blocks are then bent into a ring shape, and both ends of the blocks are welded. It should be noted that the configuration of the stator core 20 is not limited to the example illustrated in FIG. 1.

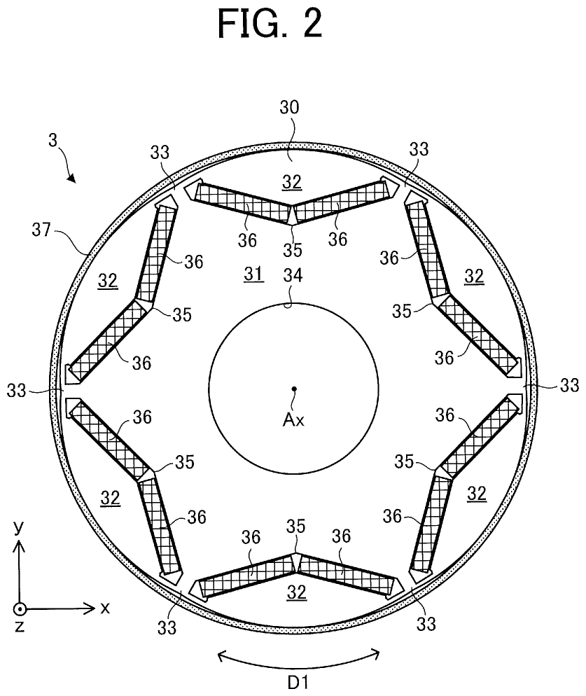

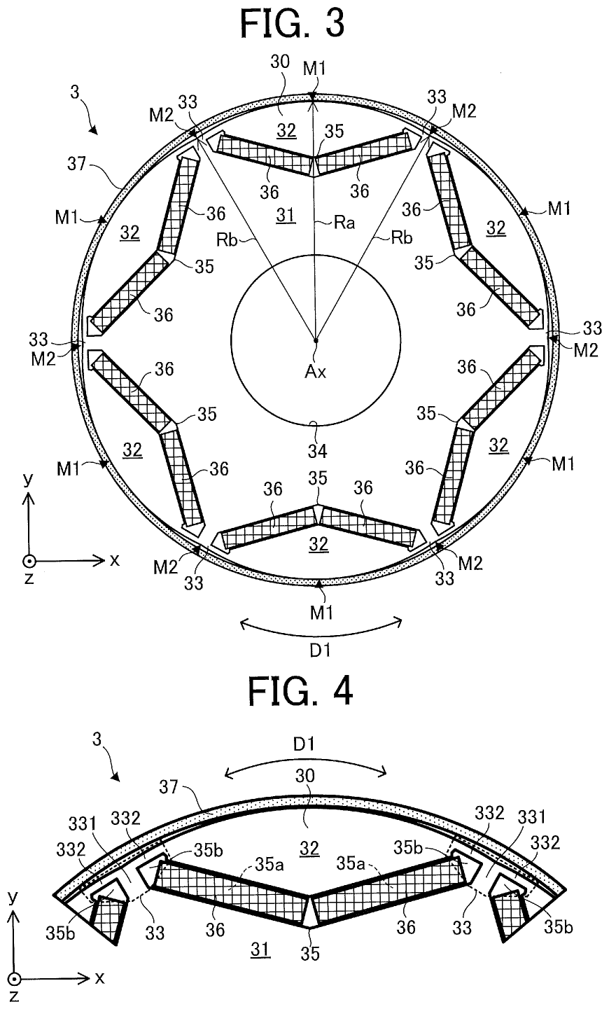

FIGS. 2 and 3 are cross-sectional views schematically illustrating the configuration of the rotor 3.

As illustrated in FIG. 2, the rotor 3 includes the rotor core 30, at least one permanent magnet 36 attached to the rotor core 30, and a holding part 37 covering an outer peripheral surface of the rotor core 30. The at least one permanent magnet 36 includes two or more permanent magnets 36.

The rotor core 30 is formed in a cylindrical shape. The rotor core 30 includes a shaft hole 34 and at least one magnet insertion hole 35.

As illustrated in FIG. 3, the rotor 3 includes at least one magnetic pole center part M1 and at least one inter-pole part M2. In this embodiment, the rotor 3 includes six magnetic pole center parts M1 and six inter-pole parts M2.

Each magnetic pole center part M1 is a center of one magnetic pole of the rotor 3 in the circumferential direction. In the example illustrated in FIG. 3, in the xy plane, each magnetic pole center part M1 is located on a line passing through the rotation center of the rotor 3 and the center of two permanent magnets 36 in one magnet insertion hole 35. Each inter-pole part M2 is a boundary between two magnetic poles that are adjacent to each other in the circumferential direction. In the example illustrated in FIG. 3, in the xy plane, each inter-pole part M2 is located on a line passing through the center of two adjacent magnet insertion holes 35.

The rotor core 30 is constituted by a plurality of electromagnetic steel sheets. The rotor core 30 is formed by, for example, stacking a plurality of electromagnetic steel sheets in the axial direction. The thickness of each electromagnetic steel sheet is, for example, 0.1 mm to 0.7 mm. In this embodiment, the thickness of each electromagnetic steel sheet of the rotor core 30 is 0.35 mm. The plurality of electromagnetic steel sheets are fixed by swaging.

A curvature of the outer edge of the rotor core 30 in the xy plane differs in the circumferential direction. Specifically, as illustrated in FIG. 3, a maximum radius of the rotor core 30 is a radius Ra of the rotor core 30 in each magnetic pole center part M1. A minimum radius of the rotor core 30 is a radius Rb of the rotor core 30 in each inter-pole part M2. The radius of the rotor core 30 gradually decreases from the magnetic pole center part M1 toward the inter-pole part M2 in the circumferential direction. Accordingly, the waveform of an induced voltage generated in the coil 25 during driving of the electric motor 1 can be made approach a sine wave. As a result, pulsations of a torque in the electric motor 1 are reduced and thus vibrations and noise in the electric motor 1 can be reduced.

It should be noted that the rotor core 30 may have a uniform outer diameter in the circumferential direction. In this case, the rotor core 30 is circular in the xy plane.

The shaft hole 34 is formed at the center of the rotor core 30 in the xy plane. The shaft hole 34 is also referred to as a center hole. A shaft (not shown) of the rotor 3 is attached to the shaft hole 34 by shrink fitting or press fitting.

In the example illustrated in FIG. 2, a plurality of magnet insertion holes 35 are formed in the circumferential direction. Specifically, the plurality of magnet insertion holes 35 are evenly arranged in the circumferential direction. In the xy plane, each magnet insertion hole 35 is a V-shaped hole. That is, a center portion of each magnet insertion hole 35 in the circumferential direction projects inward in the radial direction.

FIG. 4 is an enlarged view schematically illustrating a configuration of a part of the rotor 3. Portions surrounded by broken lines represent connecting core parts 33 described later.

Each magnet insertion hole 35 includes at least one first opening 35a that is a space where the permanent magnet 36 is disposed, and at least one second opening 35b that is a space where no permanent magnet 36 is disposed. In the example illustrated in FIG. 4, the magnet insertion hole 35 includes two first openings 35a and two second openings 35b.

In the xy plane, each first opening 35a linearly extends in the longitudinal direction. The first openings 35a communicate with the second openings 35b. In the xy plane, the width of each first opening 35a in the lateral direction is slightly larger than the thickness of each permanent magnet 36 in the lateral direction. Accordingly, the permanent magnet 36 can be easily inserted in the magnet insertion hole 35 (specifically, the first opening 35a).

The second openings 35b are located at both ends of each magnet insertion hole 35 in the circumferential direction. The second openings 35b function as flux barriers. That is, each second opening 35b reduces leakage flux (i.e., magnetic flux from the permanent magnet 36 passing through the inter-pole part M2).

In the example illustrated in FIGS. 2 and 3, six magnet insertion holes 35 are formed in the rotor core 30. In the example illustrated in FIGS. 2 and 3, each magnet insertion hole 35 is associated with one magnetic pole (i.e., a north pole or a south pole) of the rotor 3. At least one permanent magnet 36 is disposed in each magnet insertion hole 35. That is, at least one permanent magnet 36 disposed in each magnet insertion hole 35 forms one magnetic pole of the rotor 3. Thus, in the example illustrated in FIGS. 2 and 3, the rotor 3 has six poles.

It should be noted that the number of magnetic poles of the rotor 3 is two or more, and is not limited to six poles. In the example illustrated in FIGS. 2 and 3, one magnet insertion hole 35 is associated with one magnetic pole, but two or more magnet insertion holes 35 may be associated with one magnetic pole.

In the example illustrated in FIGS. 2 through 4, two permanent magnets 36 are disposed in one magnet insertion hole 35. Thus, two permanent magnets 36 disposed in one magnet insertion hole 35 form one magnetic pole. That is, in the example illustrated in FIGS. 2 through 4, two permanent magnets 36 are disposed for each magnetic pole of the rotor 3. In the xy plane, two permanent magnets 36 forming one magnetic pole are disposed in a V shape. In the example illustrated in FIGS. 2 and 3, 12 permanent magnets 36 are fixed to the rotor core 30.

Each permanent magnet 36 is a flat-plate magnet, and elongated in the axial direction. In the xy plane, each permanent magnet 36 has a width in the longitudinal direction, and has a thickness in the lateral direction. The thickness of each permanent magnet 36 in the lateral direction is, for example, 2 mm. Each permanent magnet 36 is a rare earth magnet containing neodymium (Nd), iron (Fe), and boron (B), for example.

In the xy plane, each permanent magnet 36 is magnetized in the lateral direction. Orientations of magnetic poles of two permanent magnets 36 in one magnet insertion hole 35 are the same. That is, two permanent magnets 36 in one magnet insertion hole 35 function as a north pole or a south pole with respect to the stator 2. In other words, in each magnet insertion hole 35, when one side of each permanent magnet 36 in the lateral direction is a north pole, the opposite side of the permanent magnet 36 in the lateral direction is a south pole. On the other hand, in each magnet insertion hole 35, when one side of each permanent magnet 36 in the lateral direction is a south pole, the opposite side of the permanent magnet 36 in the lateral direction is a north pole.

In the xy plane, the rotor core 30 includes one inner core part 31, at least one outer core part 32, and at least one connecting core part 33. The inner core part 31, the at least one outer core part 32, and the at least one connecting core part 33 are integrated. The inner core part 31 is also referred to as a first core part. The outer core part 32 is also referred to as a second core part. The connecting core part 33 is also referred to as a third core part.

The inner core part 31 is a part of the rotor core 30. The inner core part 31 is formed on an inner side with respect to the magnet insertion hole 35 in the radial direction. The inner core part 31 is a region between the rotation center of the rotor 3 and the magnet insertion hole 35, in the xy plane. In other words, the inner core part 31 is a region between the shaft hole 34 and the magnet insertion hole 35.

The outer core part 32 is a part of the rotor core 30. The outer core part 32 is formed on an outer side with respect to the magnet insertion hole 35 in the radial direction. In other words, the outer core part 32 is a region between the outer peripheral surface of the rotor core 30 and the magnet insertion hole 35. In the example illustrated in FIG. 2, the rotor core 30 includes a plurality of outer core parts 32 (specifically, six outer core parts 32).

The connecting core part 33 is a part of the rotor core 30. The connecting core part 33 is formed in a region between the outer peripheral surface of the rotor 3 and an end of the magnet insertion hole 35 in the circumferential direction. In other words, the connecting core part 33 is formed in a region including the inter-pole part M2 of the rotor 3. The connecting core part 33 is a region coupling the inner core part 31 and the outer core part 32 to each other. In the example illustrated in FIGS. 2 and 3, the rotor core 30 includes a plurality of connecting core parts 33 (specifically, six connecting core part 33).

As illustrated in FIG. 4, each connecting core part 33 includes a first part 331 extending in the radial direction (also referred to as a first joint part or simply a “joint part”) and a second part 332 extending in the circumferential direction (also referred to as a bridge part). Each first part 331 faces the second opening 35b in the circumferential direction. In other words, each first part 331 is adjacent to the second opening 35b in the circumferential direction. Each second part 332 is a region between the second opening 35b and the outer peripheral surface of the rotor core 30. Each second part 332 faces the second opening 35b in the radial direction. In other words, each second part 332 is adjacent to the second opening 35b in the radial direction.

The width of each second part 332 in the radial direction is smaller than the width of each first part 331 in the radial direction. Accordingly, leakage flux can be reduced, and magnetic flux of the permanent magnets 36 can be effectively used. As a result, a magnet torque in the electric motor 1 can be increased. For example, the width of each second part 332 in the radial direction is equal to the thickness of one electromagnetic steel sheet of the rotor core 30. In this embodiment, the width of each second part 332 in the radial direction is 0.35 mm.

The first part 331 is used for increasing a reluctance torque in the electric motor 1. Magnetic flux from the stator 2 passes through the first part 331 and a reluctance torque occurs. For example, the width of each first part 331 in the circumferential direction is twice as large as the thickness of one electromagnetic steel sheet of the rotor core 30. In this embodiment, the width of each first part 331 in the circumferential direction is 0.7 mm.

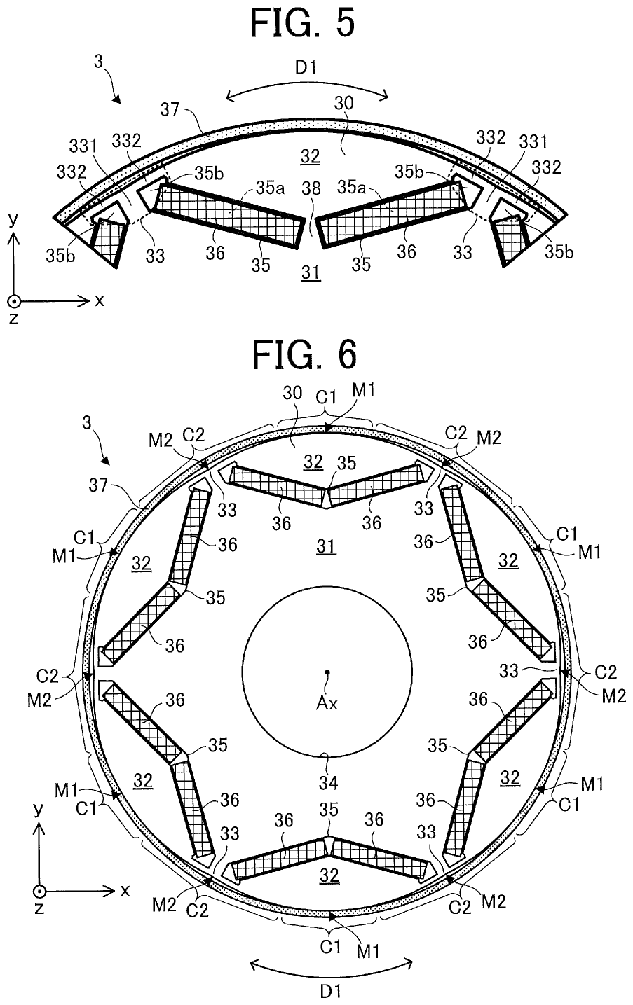

FIG. 5 is a diagram illustrating another example of the rotor core 30.

In each magnetic pole of the rotor 3, the magnet insertion hole 35 may be divided into two holes. In this case, in each magnetic pole of the rotor 3, a region 38 between two permanent magnets 36 is not a space and a part of an electromagnetic steel sheet (also referred to as a second joint part). That is, part of the rotor core 30 is present between two permanent magnets 36. Accordingly, stiffness of the rotor core 30 can be increased, and the rotor 3 can rotate at high speed in the electric motor 1.

The holding part 37 has a cylindrical shape. In the xy plane, the holding part 37 does not necessarily have a complete circle. The holding part 37 covers the outer peripheral surface of the rotor core 30, and is fixed to the rotor core 30. Accordingly, strength of the rotor 3 can be increased. The holding part 37 is fixed to the rotor core 30 by any one of an adhesive, press fitting, shrink fitting, or cool fitting.

In a case where the electric motor 1 is used for a compressor, the holding part 37 is preferably fixed to the rotor core 30 by any one of press fitting, shrink fitting, or cool fitting. Accordingly, in a high-temperature refrigerant, the holding part 37 can be sufficiently fixed to the rotor core 30.

The holding part 37 preferably covers the entire outer peripheral surface of the rotor core 30. Accordingly, strength of the rotor 3 can be further increased. The holding part 37 is in contact with part of the outer peripheral surface of the rotor core 30 other than the inter-pole part M2, and is not in contact with the outer peripheral surface of the rotor core 30 in the inter-pole part M2. In the example illustrated in FIG. 3, the holding part 37 is in contact with the outer peripheral surface of the rotor core 30 in the magnetic pole center part M1, and is not in contact with the outer peripheral surface of the rotor core 30 in the inter-pole part M2. It should be noted that the holding part 37 does not necessarily be in contact with the outer peripheral surface of the rotor core 30 in the magnetic pole center part M1. A material for the holding part 37 is a material for increasing mechanical strength of the rotor 3. The holding part 37 is made of, for example, carbon fiber reinforced plastic (CFRP), stainless, or resin.

In addition, the holding part 37 is preferably made of a non-magnetic material. Thus, a material for the holding part 37 is preferably a non-magnetic carbon fiber reinforced plastic, stainless, or resin.

The linear expansion coefficient of the holding part 37 is preferably smaller than the linear expansion coefficient of the rotor core 30. For example, in a case where the holding part 37 is made of carbon fiber reinforced plastic, the linear expansion coefficient of the holding part 37 is smaller than the linear expansion coefficient of the rotor core 30 (specifically, electromagnetic steel sheets constituting the rotor core 30).

Since the rotor 3 includes the holding part 37 described above, strength of the rotor 3 can be enhanced. Accordingly, high-speed rotation in the electric motor 1 can be achieved without the necessity for a large width of the connecting core part 33 (specifically, the second part 332) in the radial direction, and output of the electric motor 1 can be increased.

FIG. 6 is a cross-sectional view schematically illustrating a configuration of the rotor 3.

As illustrated in FIG. 6, in the rotor 3, contact regions C1 in the outer peripheral surface of the rotor core 30 are regions where the outer peripheral surface of the rotor core 30 is in contact with the holding part 37. Non-contact regions C2 in the outer peripheral surface of the rotor core 30 are regions where the outer peripheral surface of the rotor core 30 is not in contact with the holding part 37. In the example illustrated in FIG. 6, in the xy plane, a plurality of contact regions C1 and a plurality of non-contact regions C2 are present. Each non-contact region C2 is preferably longer than each contact region C1 in the circumferential direction.

Advantages of the rotor 3 will be described. Since the rotor 3 includes the holding part 37, strength of the rotor 3 can be increased. Specifically, even when the width of the connecting core part 33 (especially the second part 332) in the radial direction is small, strength of the rotor 3 can be maintained. Accordingly, leakage flux can be reduced, and magnetic flux of the permanent magnets 36 can be effectively used. As a result, a magnet torque in the electric motor 1 can be increased, and the rotor 3 can rotate at high speed.

In addition, the holding part 37 is in contact with part of the outer peripheral surface of the rotor core 30 other than the magnetic pole center part M1, and is not in contact with the outer peripheral surface of the rotor core 30 in the inter-pole part M2. Accordingly, during driving of the electric motor 1, stress generated on the rotor core 30, specifically, compressive stress, tends to be concentrated on the inter-pole part M2. Since the second part 332 of the connecting core part 33 is formed at each side of the inter-pole part M2 in the circumferential direction, compressive stress is generated on each second part 332, and magnetic permeability decreases. Accordingly, magnetic flux does not easily pass through each second part 332, and consequently, leakage flux can be reduced. As a result, a magnetic force of the rotor 3 can be enhanced and thus efficiency of the electric motor 1 can be enhanced.

As illustrated in FIG. 2, in the xy plane, the rotor 3 includes the V-shaped permanent magnets 36 for each magnetic pole of the rotor 3. Specifically, two permanent magnets 36 are disposed in the V shape. Accordingly, as compared to a rotor in which one or more permanent magnets forming one magnetic pole are linearly arranged in the xy plane, an electrical resistance of the permanent magnets 36 increases and thus an eddy-current loss on the permanent magnets 36 can be reduced. As a result, an eddy-current loss on the permanent magnets 36 during driving of the electric motor 1 is reduced and thus efficiency of the electric motor 1 can be further increased.

The maximum radius of the rotor core 30 is the radius Ra of the rotor core 30 in each magnetic pole center part M1. A minimum radius of the rotor core 30 is a radius Rb of the rotor core 30 in each inter-pole part M2. Accordingly, the waveform of an induced voltage generated in the coil 25 during driving of the electric motor 1 can be approached a sine wave. As a result, vibrations and noise in the electric motor 1 can be reduced.

It should be noted that in the xy plane, the rotor core 30 may have a uniform outer diameter in the circumferential direction. In the case where the outer diameter of the rotor core 30 is uniform in the circumferential direction, an inner diameter of the holding part 37 in the inter-pole part M2 is larger than an inner diameter of the holding part 37 in the magnetic pole center part M1 in the xy plane. Accordingly, the non-contact regions C2 can be obtained in the inter-pole parts M2 of the rotor 3, and the contact regions C1 can be obtained in the magnetic pole center parts M1 of the rotor 3. As a result, the advantages of the rotor 3 described above can be obtained.

In a case where each non-contact region C2 in the outer peripheral surface of the rotor core 30 is larger, in the circumferential direction, than each contact region C1 in the outer peripheral surface of the rotor core 30, compression strength is likely to be concentrated in a wide range including the inter-pole parts M2. Accordingly, magnetic permeability in the connecting core parts 33 (especially, the second parts 332) further decreases, and leakage flux can be further reduced. As a result, a magnetic force of the rotor 3 can be further enhanced and thus efficiency of the electric motor 1 can be further increased.

In a case where the holding part 37 is made of a non-magnetic material, leakage flux in the rotor 3 can be further reduced. As a result, a magnetic force of the rotor 3 can be further enhanced and thus efficiency of the electric motor 1 can be further increased.

When the temperature of the rotor 3 increases, the rotor core 30 expands. Thus, in the case where the linear expansion coefficient of the holding part 37 is smaller than the linear expansion coefficient of the rotor core 30, the rotor core 30 is compressed by the holding part 37. Accordingly, compressive stress is generated on the connecting core parts 33 (especially, the second parts 332). In this case, as described above, magnetic permeability in the connecting core parts 33 (especially, the second parts 332) decreases and thus leakage flux can be reduced. As a result, a magnetic force of the rotor 3 can be enhanced and thus efficiency of the electric motor 1 can be enhanced. When the rotor 3 rotates at high speed, the temperature of the rotor 3 tends to increase. Thus, in the case where the rotor 3 rotates at high speed, the advantages described above can be easily obtained.

In particular, in a case where the holding part 37 is made of carbon fiber reinforced plastic, the linear expansion coefficient of the holding part 37 is smaller than the linear expansion coefficient of the rotor core 30 (specifically, the electromagnetic steel sheets constituting the rotor core 30). Accordingly, when the temperature of the rotor 3 increases, compressive stress tends to be generated on the connecting core parts 33 (especially, the second parts 332), and magnetic permeability in the connecting core parts 33 (especially, the second parts 332) decreases and thus leakage flux can be further reduced. As a result, in high-speed rotation of the rotor 3, the advantages described above can be effectively obtained.

In addition, in the case where the holding part 37 is made of carbon fiber reinforced plastic, in high-speed rotation of the rotor 3, an increase in eddy current generated in the rotor 3 can be suppressed. In addition, carbon fiber reinforced plastic has the property of high durability to heat. Thus, in high-speed rotation of the rotor 3, even when the temperature of the rotor 3 increases, deformation of the holding part 37 can be prevented.

Furthermore, since carbon fiber reinforced plastic has high strength, the thickness of the holding part 37 can be reduced. Accordingly, the width of a gap between the stator 2 and the rotor core 30 can be reduced and thus a magnetic force of the permanent magnets 36 can be effectively used. As a result, both high-speed rotation of the rotor 3 and increase in efficiency of the electric motor 1 can be achieved. Moreover, since carbon fiber reinforced plastic shows a small degree of deformation due to a temperature change, a variation of the width of the gap between the stator 2 and the rotor core 30 can be reduced. Furthermore, in the case where the holding part 37 is made of carbon fiber reinforced plastic, an increase in eddy current occurring in the rotor 3 can be suppressed, advantageously.

The holding part 37 is preferably fixed to the rotor core 30 by any of press fitting, shrink fitting, or cool fitting. Accordingly, when rotation of the rotor 3 stops (i.e., the speed of the rotor 3 decreases), compressive stress occurs on the connecting core parts 33 of the rotor core 30. In this case, magnetic properties of the connecting core parts 33 (especially, the second parts 332) degrade, and thus, magnetic permeability decreases. As a result, when the electric motor 1 is caused to rotate at high speed again, leakage flux can be reduced. In addition, in a case where the electric motor 1 is used for a compressor, the holding part 37 can be sufficiently fixed to the rotor core 30 in a high-temperature refrigerant.

### Second Embodiment

A compressor 6 according to a second embodiment of the present invention will be described.

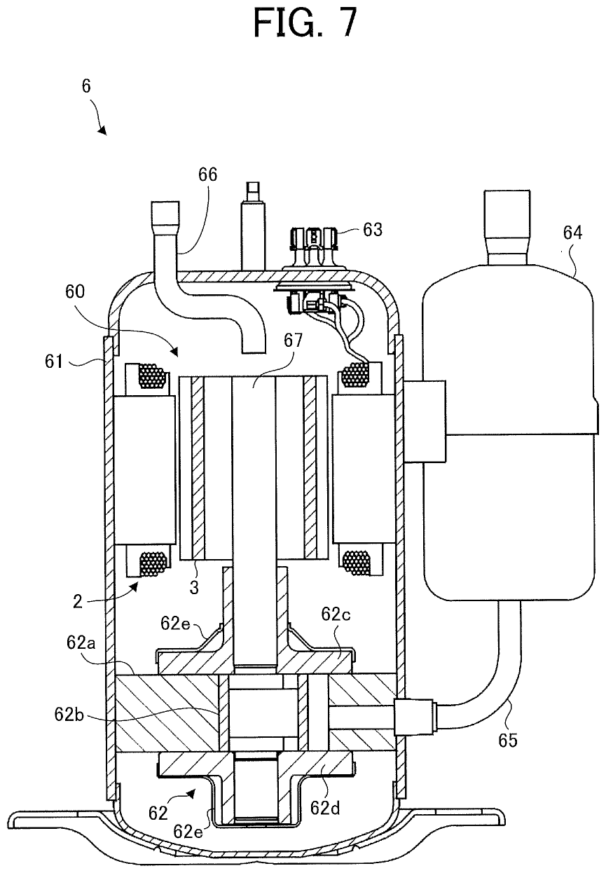

FIG. 7 is a cross-sectional view schematically illustrating a configuration of the compressor 6 according to the second embodiment.

The compressor 6 includes an electric motor 60 as an electric element, a closed container 61 as a housing, and a compression mechanism 62 as a compression element. In this embodiment, the compressor 6 is a rotary compressor. It should be noted that the compressor 6 is not limited to the rotary compressor.

The electric motor 60 is the electric motor 1 according to the first embodiment. The electric motor 60 drives the compression mechanism 62.

The closed container 61 covers the electric motor 60 and the compression mechanism 62. The closed container 61 is a cylindrical container formed of a steel sheet having a thickness of 3 mm, for example. Refrigerating machine oil for lubricating a sliding part of the compression mechanism 62 is stored in a bottom portion of the closed container 61.

The compressor 6 also includes a glass terminal 63 fixed to the closed container 61, an accumulator 64, a suction pipe 65, and a discharge pipe 66.

The compression mechanism 62 includes a cylinder 62a, a piston 62b, an upper frame 62c (first frame), a lower frame 62d (second frame), and a plurality of mufflers 62e individually attached to the upper frame 62c and the lower frame 62d. The compression mechanism 62 also includes a vane that divides the inside of the cylinder 62a into a suction side and a compression side. The compression mechanism 62 is driven by the electric motor 60.

The electric motor 60 is fixed to the inside of the closed container 61 by press fitting or shrink fitting. Instead of press fitting and shrink fitting, the stator 2 may be directly attached to the closed container 61 by welding.

A winding of the stator 2 of the electric motor 60 is supplied with electric power through the glass terminal 63.

The rotor (specifically, one side of a shaft 67) of the electric motor 60 is rotatably supported by a bearing included in each of the upper frame 62c and the lower frame 62d.

The shaft 67 is inserted in the piston 62b. The shaft 67 is rotatably inserted in the upper frame 62c and the lower frame 62d. The upper frame 62c and the lower frame 62d close an end face of the cylinder 62a. The accumulator 64 supplies a refrigerant (e.g., refrigerant gas) to the cylinder 62a through the suction pipe 65.

Next, an operation of the compressor 6 will be described. The refrigerant supplied from the accumulator 64 is sucked into the cylinder 62a from the suction pipe 65 fixed to the closed container 61. Rotation of the electric motor 60 causes the piston 62b fitted in the shaft 67 to rotate in the cylinder 62a. Accordingly, the refrigerant is compressed in the cylinder 62a.

The refrigerant flows through the mufflers 62e and moves upward in the closed container 61. The thus-compressed refrigerant is supplied to a high-pressure side of a refrigeration cycle through the discharge pipe 66.

As a refrigerant for the compressor 6, R410A, R407C, or R22, for example, can be used. It should be noted that the refrigerant for the compressor 6 is not limited to these types of refrigerant. For example, as the refrigerant for the compressor 6, a refrigerant having a small global warming potential (GWP) or the like can be used.

The compressor 6 according to the second embodiment has the advantages described in the first embodiment.

The use of the electric motor 1 according to the first embodiment as the electric motor 60 enables high-speed rotation of the electric motor 60 and enhancement of an output of the compressor 6.

The use of the electric motor 1 according to the first embodiment as the electric motor 60 can also increase efficiency of the electric motor 60, and as a result, can increase efficiency of the compressor 6.

### Third Embodiment

A refrigerating air conditioning device 7 according to a third embodiment of the present invention will be described.

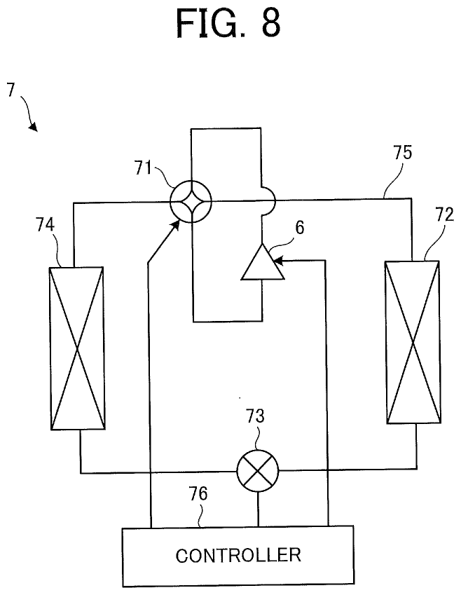

FIG. 8 is a diagram schematically illustrating a configuration of the refrigerating air conditioning device 7 according to the third embodiment.

The refrigerating air conditioning device 7 includes the compressor 6 according to the second embodiment, a four-way valve 71, a condenser 72, a pressure reducing device 73 (also referred to as an expander), an evaporator 74, a refrigerant pipe 75, and a controller 76. In the example illustrated in FIG. 8, the compressor 6, the condenser 72, the pressure reducing device 73, and the evaporator 74 are coupled to one another by the refrigerant pipe 75, and thus a refrigeration cycle is constituted.

An example of an operation of the refrigerating air conditioning device 7 will be described. The compressor 6 compresses a sucked refrigerant, and sends a high-temperature and high-pressure gas refrigerant. The four-way valve 71 switches a flow direction of refrigerant. In the example illustrated in FIG. 8, the four-way valve 71 causes the refrigerant sent from the compressor 6 to flow in the condenser 72. The condenser 72 performs heat exchange between the refrigerant sent from the compressor 6 and air (e.g., outdoor air), thereby condensing the refrigerant, and sends a liquefied refrigerant. The pressure reducing device 73 causes the refrigerant (i.e., liquefied refrigerant) from the condenser 72 to expand and sends a low-temperature and low-pressure liquefied refrigerant.

The evaporator 74 performs heat exchange between the low-temperature and low-pressure liquefied refrigerant sent from the pressure reducing device 73 and air (e.g., indoor air), thereby gasifying the refrigerant, and sends the gasified refrigerant (e.g., gas refrigerant). Air from which heat is taken by the evaporator 74 is supplied to a target space (e.g., into a room) by, for example, an air blower. Operations of the four-way valve 71 and the compressor 6 are controlled by the controller 76.

The refrigerating air conditioning device 7 according to the third embodiment has the advantages described in the second embodiment.

In addition, since the refrigerating air conditioning device 7 includes the compressor 6, efficiency of the refrigerating air conditioning device 7 can be further enhanced.

Furthermore, since the refrigerating air conditioning device 7 includes the compressor 6, an output of the refrigerating air conditioning device 7 can be further enhanced.

The electric motor 1 described in the first embodiment is applicable to a driving source in equipment, such as an air blower, a ventilator, a household electrical appliance, or a machine tool, as well as the compressor 6 and the refrigerating air conditioning device 7.

The examples described in the foregoing embodiments are merely examples of the content of the present invention, and may be combined with other known techniques. Part of the configurations may be omitted or changed within the range not departing from the gist of the invention.

1. A rotor including a magnetic pole center part and an inter-pole part, the rotor comprising:
at least one permanent magnet;
a rotor core including a magnet insertion hole including a first opening in which the at least one permanent magnet is disposed and a second opening in which the at least one permanent magnet does not disposed, an inner core part formed on an inner side with respect to the magnet insertion hole in a radial direction, an outer core part formed on an outer side with respect to the magnet insertion hole in the radial direction, and a connecting core part formed between an outer peripheral surface of the rotor and an end of the magnet insertion hole in a circumferential direction; and
a holding part covering an outer peripheral surface of the rotor core, wherein
the holding part is in contact with part of the outer peripheral surface of the rotor core other than the inter-pole part and is not in contact with the outer peripheral surface of the rotor core at the inter-pole part.

2. The rotor according to claim 1, wherein
a maximum radius of the rotor core is a radius of the rotor core in the magnetic pole center part, and
a minimum radius of the rotor core is a radius of the rotor core in the inter-pole part.

3. The rotor according to claim 1, wherein the rotor core has a circular shape in a plane orthogonal to an axial direction, and an outer diameter of the rotor core is uniform in the circumferential direction.

4. The rotor according to claim 1, wherein the holding part has a cylindrical shape.

5. The rotor according to claim 1, wherein a non-contact region of the outer peripheral surface where the outer peripheral surface is not in contact with the holding part is longer, in the circumferential direction, than a contact region where the outer peripheral surface is in contact with the holding part.

6. The rotor according to claim 1, wherein the holding part is made of a non-magnetic material.

7. The rotor according to claim 1, wherein the holding part has a linear expansion coefficient smaller than a linear expansion coefficient of the rotor core.

8. The rotor according to claim 1, wherein the holding part is made of carbon fiber reinforced plastic.

9. The rotor according to claim 1, wherein the holding part is fixed to the rotor core by press fitting, shrink fitting, or cooling fitting.

10. The rotor according to claim 1, wherein
the at least one permanent magnet comprises two permanent magnets forming one magnetic pole of the rotor, and
in a plane orthogonal to an axial direction, the two permanent magnets are disposed in a V shape.

11. The rotor according to claim 10, wherein part of the rotor core is present between the two permanent magnets.

12. An electric motor comprising:
a stator; and
the rotor according to any claim 1 rotatably disposed inside the stator.

13. A compressor comprising:
a closed container;
a compression mechanism disposed inside the closed container; and
the electric motor according to claim 12 to drive the compression mechanism.

14. A refrigerating air conditioning device comprising: the compressor according to claim 13; a condenser; a pressure reducing device; and an evaporator.
